(19) United States
(12) Patent Application Publication
(10) Pub. No.: US 2007/0211137 A1
(43) Pub. Date: Sep. 13, 2007

(54) Optical writing unit and method of manufacturing the same

(75) Inventor: Kozo Yamazaki, Takarazuka City (JP)

Correspondence Address: HARNESS, DICKEY & PIERCE, P.L.C., P.O. BOX 8910, RESTON, VA, 20195, US

(73) Assignee: RICOH COMPANY., LTD.

(21) Appl. No.: 11/715,479

(22) Filed: Mar. 8, 2007

(30) Foreign Application Priority Data
Mar. 8, 2006 (JP) JP2006-063265

(51) Int. Cl. B41J 15/14

(52) U.S. Cl. 347/243

(57) ABSTRACT

An optical writing unit includes a housing, at least one light source, and/or at least one aperture member. In at least one embodiment, the at least one light source emits a light beam, and the at least one aperture member passes the light beam emitted from the at least one light source. In at least one embodiment, the at least one aperture member is integrally formed with the housing and/or the at least one light source is directly fixed to the housing by applying pressure.

### TECHNICAL FIELD

The present disclosure generally relates to an optical writing unit, for example, to an optical writing unit for use in an image forming apparatus and methods of manufacturing the same.

### BACKGROUND

A plurality of functional aspects such as higher quality image, higher speed printing, more space-saving, more energy-saving, and/or cost reducing have been demanded from a market for an image forming apparatus (e.g., laser printer, digital copier).

With such background, for example, optical parts configuring an optical writing unit may need to cope with a demand such as higher performance and/or lower manufacturing cost. A related art image forming apparatus may have an optical writing unit having higher performance and lower cost manufacturing.

One related art image forming apparatus may include a plurality of light sources substantially aligned with scan faces for an image forming apparatus, and may include an optical writing unit having a housing integrally formed with an aperture member.

However, in such related art image forming apparatus, a number of parts for image forming apparatus may become relatively greater, which may not be preferable from a viewpoint of reducing manufacturing cost of an image forming apparatus.

### SUMMARY

The present disclosure relates to an optical writing unit. The optical writing unit may include a housing, at least one light source, and/or at least one aperture member. The at least one light source may emit a light beam, and the at least one aperture member may pass through the light beam emitted from the at least one light source. The at least one aperture member may be integrally formed with the housing and/or the at least one light source may be directly fixed to the housing by applying pressure.

The present disclosure also relates to an image forming apparatus having an optical writing unit. The optical writing unit may include a housing, at least one light source, and/or at least one aperture member. The at least one light source may emit a light beam, and the at least one aperture member may pass the light beam emitted from the at least one light source. The at least one aperture member may be integrally formed with the housing and/or the at least one light source may be directly fixed to the housing by applying pressure.

The present disclosure also relates to a method of manufacturing a optical writing unit including providing a housing including at least one integrally-formed aperture member and/or directly fixing at least one light source to the housing by applying pressure to the at least one light source.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic configuration of an image forming apparatus including an optical writing unit according to an example embodiment;

FIG. 2 is a schematic plan view of an optical writing unit according to an example embodiment;

FIG. 3 is a schematic cross-sectional view of an optical writing unit according to an example embodiment;

FIG. 4 is a schematic perspective view of an optical device arrangement according to an example embodiment;

FIG. 5 is a schematic perspective view of another optical device arrangement according to an example embodiment; and

FIG. 6 is a schematic cross-sectional view of another optical device arrangement according to an example embodiment.

The accompanying drawings are intended to depict example embodiments and should not be interpreted to limit the scope thereof. The accompanying drawings are not to be considered as drawn to scale unless explicitly noted.

### DETAILED DESCRIPTION OF EXAMPLE EMBODIMENTS

It will be understood that if an element or layer is referred to as being “on,” “against,” “connected to” or “coupled to” another element or layer, then it can be directly on, against connected or coupled to the other element or layer, or intervening elements or layers may be present. In contrast, if an element is referred to as being “directly on”, “directly connected to” or “directly coupled to” another element or layer, then there are no intervening elements or layers present.

Like numbers refer to like elements throughout. As used herein, the term “and/or” includes any and all combinations of one or more of the associated listed items.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

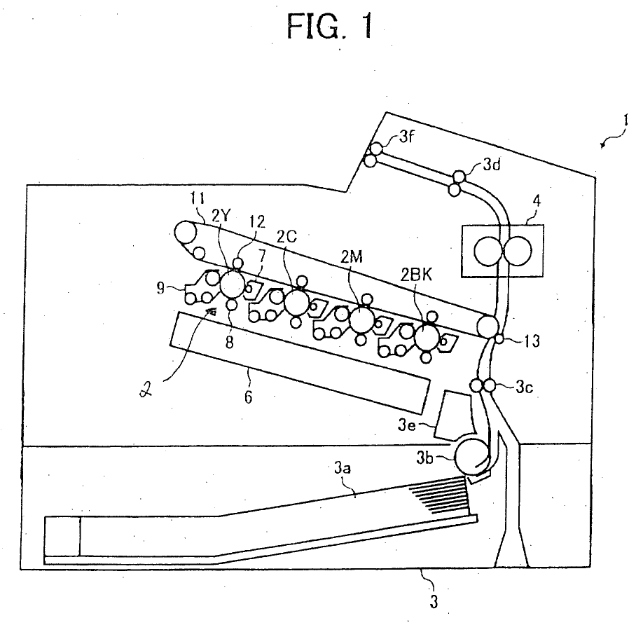

Referring now to the drawings, wherein like reference numerals designate identical or corresponding parts throughout the several views, an image forming apparatus including an optical writing unit according to an example embodiment is described with particular reference to FIGS. 1 to 3.

FIG. 1 is a schematic configuration of an image forming apparatus 1 including an optical writing unit according to an example embodiment.

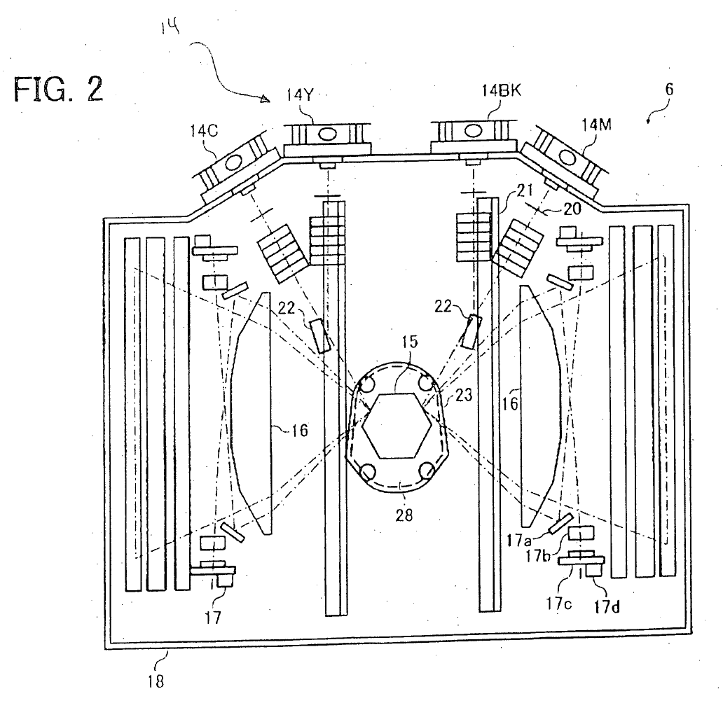

FIG. 2 is a schematic plan view of an optical writing unit according to an example embodiment.

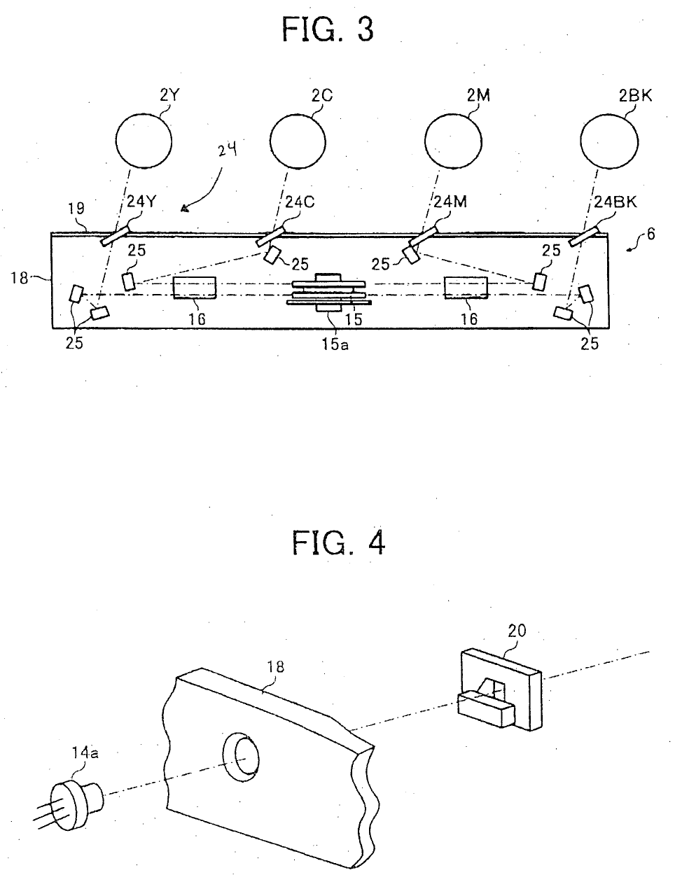

FIG. 3 is a schematic cross-sectional view of the optical writing unit according to an example embodiment.

The image forming apparatus 1 shown in FIG. 1 may be a color laser printer, but need not be limited as such.

As shown in FIG. 1, the image forming apparatus 1 may include photosensitive members 2Y, 2C, 2M, and 2BK, a sheet feeder 3, an optical writing unit 6, a developing unit 9, a primary transfer unit 12, a secondary transfer unit 13, a cleaning unit 7, a charging unit 8, and/or a fixing unit 4.

As shown in FIG. 1, each of the photosensitive members 2Y, 2C, 2M, and 2BK may be surrounded with the cleaning unit 7, charging unit 8, developing unit 9, and/or primary transfer unit 12.

Hereinafter, the photosensitive members 2Y, 2C, 2M, and 2BK may be collectively termed as “photosensitive member 2,” as required, because the photosensitive members 2Y, 2C, 2M, and 2BK may have similar configurations.

The charging unit 8 may include a roller made of electrically conductive material. A power unit (not shown) may supply a charging voltage to the roller, and the roller may charge a surface of the photosensitive member 2 uniformly.

The optical writing unit 6 may include a light source, which may emit a laser beam generated according to image data, which may be scanned by a scanner (not shown), for example.

The optical writing unit 6 may irradiate the laser beam onto a surface of the photosensitive member 2 to form an electrostatic latent image on the photosensitive member 2.

The developing unit 9 may develop the electrostatic latent image on the photosensitive member 2 with a developing agent (e.g., toner).

The primary transfer unit 12 may then transfer such developed image on the photosensitive member 2 to the intermediate transfer belt 11.

After transferring the developed image to the intermediate transfer belt 11, the cleaning unit 7 may remove developing agent (e.g., toner) remaining on the photosensitive member 2.

The developed image transferred to the intermediate transfer belt 11 may then be transferred to a transfer sheet 3a (e.g., paper) using the secondary transfer unit 13. As shown in FIG. 1, the transfer sheet 3a may be stacked in the sheet feeder 3.

The transfer sheet 3a may be fed and transported one by one to a registration roller 3c using a feed roller 3b. The feed roller 3b may be configured with a support member 3e as shown in FIG. 1.

The registration roller 3c may further transport the transfer sheet 3a to the above-mentioned secondary transfer unit 13.

Using the secondary transfer unit 13, the developed image may be transferred from the intermediate transfer belt 11 to the transfer sheet 3a.

Then, the transfer sheet 3a may be transported to the fixing unit 4. The fixing unit 4 may fix the image on the transfer sheet 3a by applying heat and pressure to the transfer sheet 3a.

After fixing the image on the transfer sheet 3a, the transfer sheet 3a may be ejected to an ejection tray using a transport roller 3d and ejection roller 3f.

Hereinafter, the optical writing unit 6 is explained with reference to FIGS. 2 and 3.

As shown in FIGS. 2 and 3, the optical writing unit 6 may include a housing 18 and a cover 19, which may contain a plurality of elements explained below.

As shown in FIGS. 2 and 3, the optical writing unit 6 may include a light source unit 14, a light-deflecting element 15, a focusing element 16, and/or a synchronization detector 17, for example.

The light source unit 14 may include a laser diode unit (LD unit), which emits a laser beam, for example.

The light-deflecting element 15 may be rotated by a driver 15a (e.g., motor), and may deflect a laser beam, which is generated by modulating an image signal obtained by scanning an original image. The light-deflecting element 15 may include a polygon mirror, for example.

The focusing element 16 may focus the laser beam, deflected by the light-deflecting element 15, on the photosensitive member 2.

The synchronization detector 17 may detect a scanning timing of laser beam, wherein the scanning timing may include a timing for starting a scanning process by a laser beam.

In an example embodiment, the light source unit 14 may include four light source units to irradiate a laser beam to a surface of each of the photosensitive members 2 as shown in FIG. 2.

As shown in FIG. 2, one set of two light source units 14 may be provided on one side with respect to the light-deflecting element 15, and another one set of two light source units 14 may be provided on another side with respect to the light-deflecting element 15.

The light source unit 14 may include a light source (e.g. semiconductor laser), a collimating lens, and a circuit board, and/or a support member, for example.

The collimating lens may collimate laser beams, emitted by the light source as divergent rays, into a substantially parallel laser beams.

The circuit board, supported by the support member, may control a light emission of the light source.

The laser beam emitted from the light source unit 14 may enter the light-deflecting element 15 via an aperture member 20 and a cylinder lens 21.

In a configuration shown in FIG. 2, two laser beams may enter one side of the light-deflecting element 15. In order for the two laser beams to separately enter the light-deflecting element 15, a mirror 22 may be provided in a light path for one of two laser beams as shown in FIG. 2

If the light-deflecting element 15 may be rotated at a relatively higher speed such as 30,000 rpm (revolution per minute) or more, a soundproof glass 23 may be provided around the light-deflecting element 15 to reduce a noise-generation at the light-deflecting element 15, for example.

For example, as shown in FIG. 2, the light-deflecting element 15 may be covered by the soundproof glass 23 provided on both side of the light-deflecting element 15, and a sound cover 28 provided over the light-deflecting element 15.

The laser beam deflected by the light-deflecting element 15 may then enter the focusing element 16.

Then, the laser beam may be guided to the photosensitive member 2 via a mirror 25 as shown in FIG. 3.

As shown in FIG. 3, the laser beam may enter each of the photosensitive members 2Y, 2C, 2M, and 2BK with a substantially similar irradiating angle.

The synchronization detector 17 may be used for determining a scanning (or writing) timing on the photosensitive member 2.

The synchronization detector 17 may include a focus lens 17b, a photoelectric element 17c, and/or an electric circuit board 17d, for example. These elements may be supporting by a support member (not shown).

The laser beam, passed through the focus lens 16, may be reflected by a synchronization detection mirror 17a, and then received by the photoelectric element 17c to determine a scanning (or writing) timing.

Such synchronization detection of laser beam may be conducted before conducting an actual scanning operation, for example.

Furthermore, such synchronization detection of laser beam may be conducted to detect a variation of speed (or time) of one scanning operation. In such a case, the synchronization detector 17 may be provided on a position that can detect the laser beam, which has been just used for one scanning operation.

In FIG. 2, the synchronization detector 17 may be provided on positions that can detect the laser beam before and after one scanning operation, for example.

As shown in FIG. 2, the synchronization detector 17 may detect a scanning light beam coming from the light-deflecting element 15.

If the light-deflecting element 15 may have a double-decked structure and two light beams may enter such light-deflecting element 15, one synchronization detector 17 may used to detect synchronization timing for both of the two light beams, for example.

In FIG. 3, one optical writing devise (e.g., the optical writing devise 6) may emit laser beams to the photosensitive members 2Y, 2C, 2M, and 2BK.

However, although not shown, another configuration that different optical writing units may irradiate laser beams to each of the photosensitive members 2Y, 2C, 2M, and 2BK may be employed. For example, four optical writing units may be provided for the photosensitive members 2Y, 2C, 2M, and 2BK, respectively.

The optical writing unit may further include dust-proof members 24Y, 24C, 24M, and 24BK (hereinafter, “dust-proof member 24”), for example, as shown in FIG. 3.

The dust-proof member 24 may be provided on a light-emitting opening of the optical writing unit 6 to reduce or prevent an intrusion of foreign particles (e.g., dust, toner) into the optical writing unit 6. The dust-proof member 24 may be a flat glass, for example.

In FIG. 3, the dust-proof members 24 may be provided on the cover 19 of the optical writing unit 6.

As such, the optical writing unit 6 may include plurality of parts in the housing 18 covered by the cover 19.

FIG. 4 is a schematic perspective view of an optical device arrangement according to an example embodiment.

In FIG. 4, the housing 18 and aperture member 20 may be integrally formed. A light source 14a unit may be fit in the housing 18 by applying pressure.

Aperture member 20 may be formed on the housing 18 with a die-cut method, for example. The aperture member 20 may be formed by conducting a die-cut method in a propagation direction of laser beam of the light source 14a unit.

Because the housing 18 and aperture member 20 may be integrally formed and the light source 14a unit may be directly fit in the housing 18 by applying pressure, the optical writing unit 6 may be configured with a smaller number of parts, which may reduce manufacturing cost.

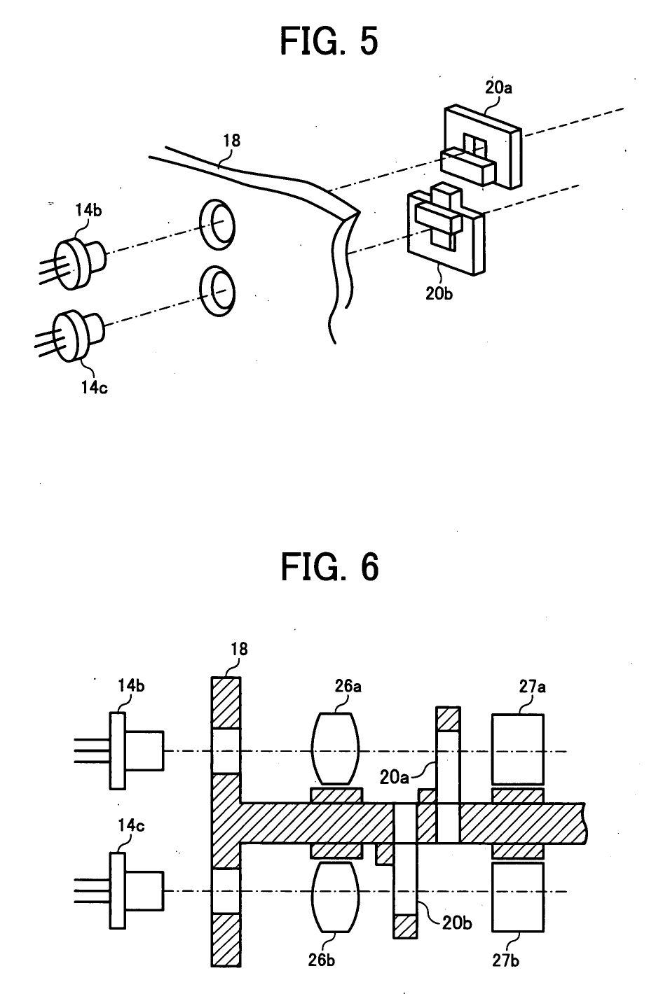

FIG. 5 is another schematic perspective view of an optical device arrangement according to an example embodiment.

An image forming apparatus, having a plurality of photoconductive members, may have an optical writing unit having a plurality of light sources to scan the plurality of photoconductive members.

Such optical writing unit may have the light-deflecting element 15, which may include scan faces arranged in a double-decked manner, in which the light-deflecting element 15 may have a upper scan face and a lower scan face, for example.

In such an optical writing unit, an aperture member 20a and aperture member 20b may be integrally formed on the housing 18.

For example, the aperture member 20a may be provided for the upper scan face of the light-deflecting element 15, and the aperture member 20b may be provided for the lower scan face of the light-deflecting element 15.

As shown in FIG. 5, a position of the aperture member 20a and a position of the aperture member 20b in the optical writing unit 6 may be separate from each other, for example.

For example, a position of the aperture member 20a and a position of the aperture member 20b in the optical writing unit 6 may be shifted with respect to each other in a light propagation direction.

As shown in FIG. 5, light sources 14b and 14c, corresponding to the aperture member 20a and 20b respectively, may be directly fit into the housing 18 by applying pressure.

Because the housing 18 and aperture members 20a and 20b may be integrally formed and the light sources 14b and 14c may be directly fit in the housing 18 by applying pressure, the optical writing unit 6 having a plurality of scan faces may be configured with a smaller number of parts, which may reduce manufacturing cost.

FIG. 6 is another schematic cross-sectional view of an optical device arrangement according to an example embodiment.

In a configuration shown in FIG. 6, collimating lenses 26a and 26b and cylinder lenses 27a and 27b may be attached to the housing 18.

When attaching the collimating lenses 26a and 26b and cylinder lenses 27a and 27b to the housing 18, a light-axis adjustment and collimating adjustment may be conducted at least for the collimating lenses 26a and 26b.

After conducting such adjustment, the collimating lenses 26a and 26b may be fixed to the housing 18 with an adhesive material, for example. With such an adhesive bonding method, the collimating lenses 26a and 26b may be fixed to the housing 18 without using a fixing member such as screw.

Furthermore, the cylinder lenses 27a and 27b may be similarly fixed to the housing 18 with an adhesive material. With such an adhesive bonding method, the cylinder lenses 27a and 27b may be fixed to the housing 18 without using a fixing member such as screw.

A positional adjustment for the cylinder lenses 27a and 27b may be conducted or may not be conducted depending on a requirement on the cylinder lenses 27a and 27b.

As explained above, because the collimating lenses 26a and 26b and cylinder lenses 27a and 27b may be fixed to the housing 18 with an adhesive bonding method, a fixing member (e.g., screw) need not be used for fixing the collimating lenses 26a and 26b and cylinder lenses 27a and 27b to the housing 18.

Accordingly, the optical writing unit 6 may be configured with a smaller number of parts, which may reduce manufacturing cost.

The above-explained configurations for the optical writing unit 6 shown in FIGS. 5 and 6 may have two scan faces. If an image forming apparatus has four photoconductive members, four scan faces may be preferably used for scanning each of the four photoconductive members.

In such a case, the above-explained configuration in FIGS. 5 and 6 may be doubled in number so that the four photoconductive members may be scanned efficiently.

Numerous additional modifications and variations are possible in light of the above teachings. It is therefore to be understood that within the scope of the appended claims, the disclosure may be practiced otherwise than as specifically described herein.

This application claims priority from Japanese patent application No. 2006-063265 filed on Mar. 8, 2006 in the Japan Patent Office, the entire contents of which is hereby incorporated by reference herein.

What is claimed is:

1. An optical writing unit, comprising:
a housing;
at least one light source configured to emit a light beam; and
at least one aperture member, corresponding to each of the at least one light sources, configured to pass the light beam emitted from the at least one light source,
wherein the at least one aperture member is integrally formed with the housing, and the at least one light source is directly fixed to the housing by applying pressure.

2. The optical writing unit according to claim 1, further comprising at least one light-deflecting element within the housing having a plurality of scan faces including a first face and a second face in a double-decked manner, and the first face is aligned with a first light source of the at least one light source and a first aperture member of the at least one aperture member and the second face is aligned with a second light source of the at least one light source and a second aperture member of the at least one aperture member, and wherein the first and second aperture members are integrally formed with the housing while shifting positions of the first and second aperture members with respect to each other in a light propagation direction of the first and second light sources.

3. The optical writing unit according to claim 1, further comprising at least one collimating lens and at least one cylinder lens, and wherein the at least one collimating lens and the at least one cylinder lens are directly fixed to the housing with an adhesive material.

4. The optical writing unit according to claim 2, wherein the at least one light-deflecting element receives light beams emitted by the first and second light sources from a plurality of different directions with respect to the at least one light-deflecting element.

5. An image forming apparatus, comprising:
an optical writing unit according to claim 1.

6. A method of manufacturing an optical writing unit, comprising:
providing a housing including at least one integrally-formed aperture member; and
directly fixing at least one light source to the housing by applying pressure to the at least one light source.

7. The method according to claim 6, further comprising:
providing at least one light-deflecting element within the housing having a plurality of scan faces including a first face and a second face in a double-decked manner, where the first face is aligned with a first light source of the at least one light source and a first aperture member of the at least one aperture member and the second face is aligned with a second light source of the at least one light source and a second aperture member of the at least one aperture member, and wherein the first and second aperture members are integrally formed with the housing while shifting positions of the first and second aperture members with respect to each other in a light propagation direction of the first and second light sources.

8. The method according to claim 6, further comprising:
directly fixing at least one collimating lens and at least one cylinder lens to the housing with an adhesive material.

9. The method according to claim 7, wherein the at least one light-deflecting element receives light beams emitted by the first and second light sources from a plurality of different directions with respect to the light-deflecting element.
